(19) United States
(12) Patent Application Publication
(10) Pub. No.: US 2026/0138430 A1
(43) Pub. Date: May 21, 2026

(54) Protective Windshield Cover Device

(71) Applicant: Josha Townser, Kansas City, MO (US)

(72) Inventor: Josha Townser, Kansas City, MO (US)

(21) Appl. No.: 18/954,694

(22) Filed: Nov. 21, 2024

(51) Int. Cl. B60J 11/08

(52) U.S. Cl. CPC B60J 11/08

(57) ABSTRACT

A protective windshield cover device for inhibiting damage to a windshield includes a plate having a peripheral shape that is designed to be positionable within a perimeter edge of a windshield of a vehicle. The plate is designed to cover a central portion of the windshield. The plate includes a tempered glass material that is designed to inhibit impact damage to the windshield of the vehicle while the plate is positioned against the outer surface of the windshield. An adhesive material is positioned to cover an interior face of the plate wherein the adhesive material is designed to adhesively engage the windshield to adhesively couple the plate to the windshield.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to protective covers and more particularly pertains to a new protective cover for inhibiting damage to a windshield.

### (2) Description of Related Art including information disclosed under 37 CFR 1.97 and 1.98

The prior art relates to protective covers. Protective covers are commonly used, particularly to protect fragile screens and surfaces. For example, many smartphone users place screen protectors over their smartphone touch screens to protect the touch screens from scratching, cracking, or breaking. Like smartphone touch screens, windshields of vehicles are also prone to being cracked, chipped, or otherwise damaged. Such damage can often require replacement of the entire windshield, which can be very expensive. Driving with a cracked windshield is also illegal in many states because the cracks can obstruct the driver's view. Accordingly, cracked windshields can also lead to missed work or appointments because the user's vehicle is not safe to drive until the windshield is repaired or replaced. Thus, there is a need in the art for a protective cover that can be positioned over a windshield to protect the windshield from impact damage. Ideally, such a cover would be easy for the user to install themselves as an after-market addition, as well as being easy for manufacturers to install on newly built cars.

### (h) BRIEF SUMMARY OF THE INVENTION

An embodiment of the disclosure meets the needs presented above by generally comprising a plate having a peripheral shape that is configured to be positionable within a perimeter edge of a windshield of a vehicle. The plate is configured to cover a central portion of the windshield. The plate includes a tempered glass material that is configured to inhibit impact damage to the windshield of the vehicle while the plate is positioned against the outer surface of the windshield. An adhesive material is positioned to cover an interior face of the plate wherein the adhesive material is configured to adhesively engage the windshield to adhesively couple the plate to the windshield.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a protective windshield cover device according to an embodiment of the disclosure.

FIG. 2 is a rear perspective view of an embodiment of the disclosure.

FIG. 3 is a cross-sectional view of an embodiment of the disclosure.

FIG. 4 is a side perspective view of an embodiment of the disclosure.

FIG. 5 is an in-use view of an embodiment of the disclosure.

### (j) DETAILED DESCRIPTION OF THE INVENTION

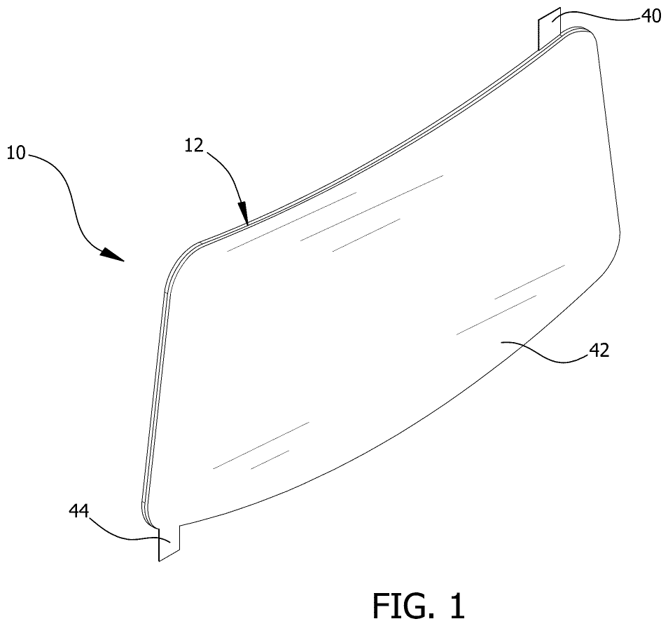

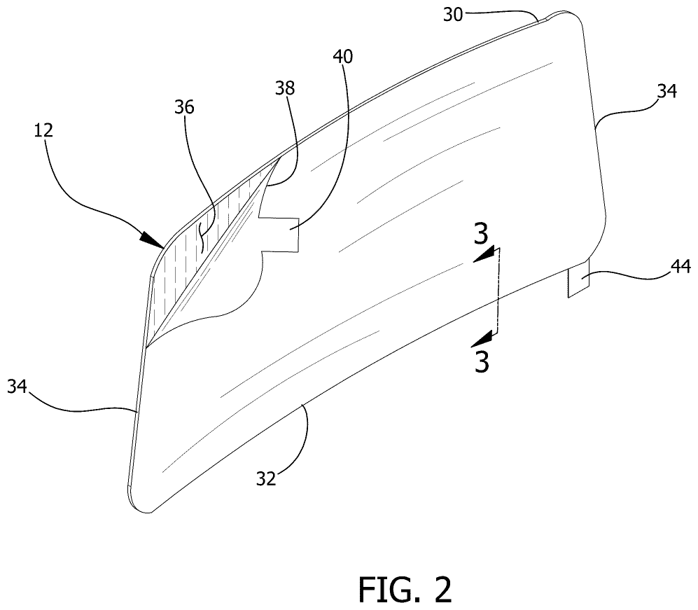

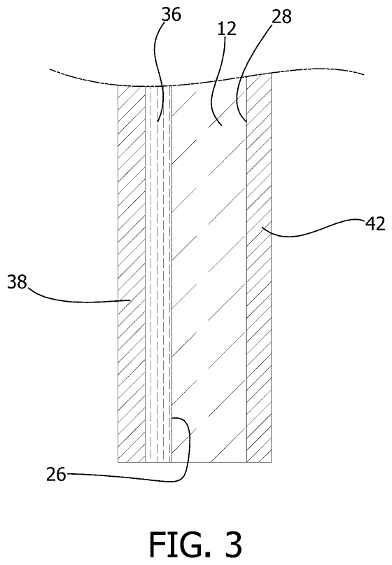

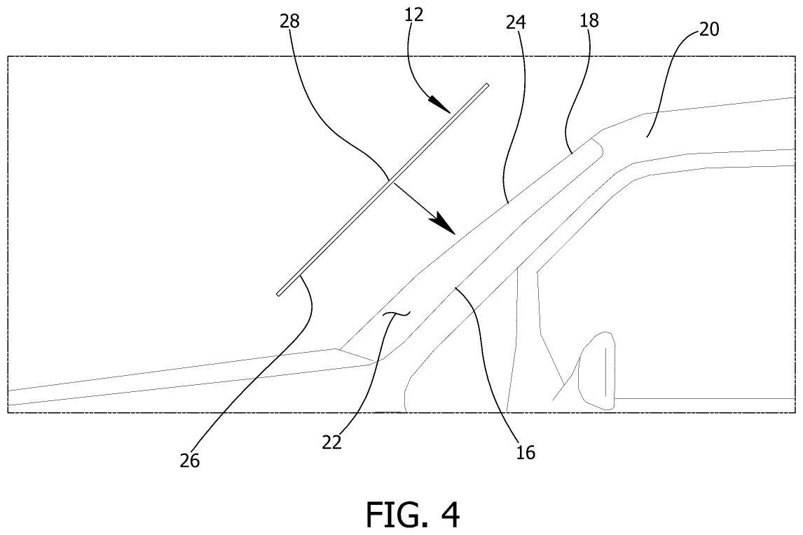

With reference now to the drawings, and in particular to FIGS. 1 through 5 thereof, a new protective cover embodying the principles and concepts of an embodiment of the disclosure and generally designated by the reference numeral 10 will be described.

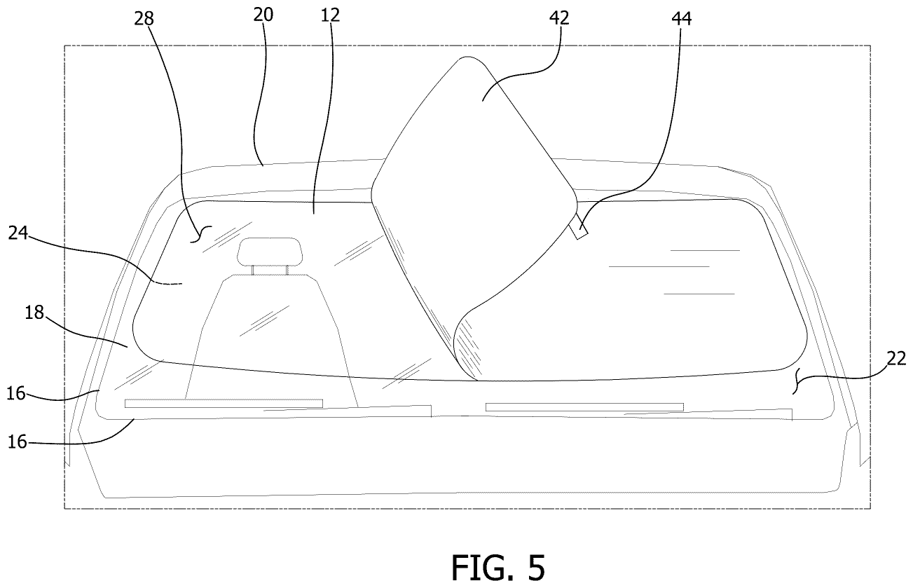

As best illustrated in FIGS. 1 through 5, the protective windshield cover device 10 generally comprises a plate 12 that has a peripheral shape that is configured to be positionable within a perimeter edge 16 of a windshield 18 of a vehicle 20. For example, the plate 12 may be configured to be positionable against an outer surface 22 of the windshield 18 of the vehicle 20 and wherein the plate 12 is configured to cover 38 a central portion 24 of the outer surface 22 of the windshield 18. For example, as shown in FIG. 5, the peripheral shape of the plate 12 may have a length or a width that is less than the length or the width of the windshield 18 so that the peripheral shape of the plate 12 fits within the perimeter edge 16 of the windshield 18. In such embodiments, portions of the windshield 18 may remain uncover 38ed by the plate 18 while the central portion 24 of the windshield 18 is cover 38ed by the plate 18. In other words, the edges of the plate 12 may be spaced from the perimeter edge 16 of the windshield 18. In other embodiments, the peripheral shape of the plate 12 may be complementary to the shape of the windshield 18 wherein the edges of the plate 12 are positioned adjacent to, or against, the perimeter edge 16 of the windshield 18 and wherein the plate 12 cover 38s the entire outer surface 22 of the windshield.

The plate 12 generally includes a tempered glass material. The tempered glass material is configured to inhibit impact damage to the central portion 24 of the windshield 18 of the vehicle 20 while the plate 12 is positioned against the outer surface 22 of the windshield 18. In other words, the tempered glass material of the plate 12 protects the portions of the windshield 18 that are cover 38ed by the plate 12. The plate 12 may be transparent wherein the plate 12 is configured to facilitate visibility through the windshield 18.

The plate 12 generally has an interior face 26 and an exterior face 28. The plate 12 also generally has a top edge 30, a bottom edge 32, and a pair of opposing lateral edges 34 that are coupled to and extend between the top edge 30 and the bottom edge 32 to define the peripheral shape of the plate 12. The plate 12 may have a thickness that is measured between the interior face 26 and the exterior face 28. The thickness may be consistent across the plate 12 within the peripheral shape.

The interior face 26 may be concavely arcuate between the pair of opposing lateral edges 34 wherein the interior face 26 is configured to be positionable flush against the outer surface 22 of the windshield 18 of the vehicle 20. The exterior face 28 may be convexly arcuate between the pair of opposing lateral edges 34.

The top edge 30 may be concavely arcuate between the pair of opposing lateral edges 34. The bottom edge 32 may be convexly arcuate between the pair of opposing lateral edges 34. The plate 12 may have rounded corners between the top edge 30 and each opposing lateral edge of the pair of opposing lateral edges 34. The plate 12 may have rounded corners between the bottom edge 32 and each opposing lateral edge of the pair of opposing lateral edges 34.

An adhesive material 36 is generally positioned on the interior face 26 of the plate 12. For example, the adhesive material 36 may be positioned to cover 38 the interior face 26 of the plate 12. The adhesive material 36 is generally configured to adhesively engage the outer surface 22 of the windshield 18 to adhesively couple the plate 12 to the windshield 18. The adhesive material 36 may be transparent wherein the adhesive material 36 is configured to facilitate visibility through the windshield 18.

A cover 38 may be removably affixed to the adhesive material 36. The cover 38 is generally configured to inhibit debris from damaging the adhesive material 36 while the cover 38 is affixed to the adhesive material 36. The cover 38 may have a size that is complementary to a size of the interior face 26 of the plate 12 wherein the cover 38 is positioned to cover 38 the adhesive material 36 while the cover 38 is affixed to the adhesive material 36.

A tab 40 may be coupled to and extend from the cover 38. For example, the tab 40 may extend upwardly from the cover 38, and may be positioned to extend upwardly past the top edge 30 of the plate 12 while the cover 38 is affixed to the adhesive material 36. The tab 40 is generally configured to facilitate removal of the cover 38 from the adhesive material 36. The tab 40 may be intrinsically formed with the cover 38. The tab 40 may be rectangular, although other shapes are also contemplated.

A dust wrapper 42 may be removably affixed to the exterior face 28 of the plate 12. The dust wrapper 42 is generally configured to inhibit debris from damaging the exterior face 28 of the plate 12 while the dust wrapper 42 is affixed to the exterior face 28 of the plate 12. The dust wrapper 42 may have a size that is complementary to a size of the exterior face 28 of the plate 12 wherein the dust wrapper 42 is positioned to cover 38 the exterior face 28 of the plate 12 while the dust wrapper 42 is affixed to the exterior face 28 of the plate 12.

A panel 44 may be coupled to and extend from the dust wrapper 42. For example, the panel 44 may extend downwardly from the dust wrapper 42, and the panel 44 may be positioned to extend downwardly past the bottom edge 32 of the plate 12 while the dust wrapper 42 is affixed to the exterior face 28 of the plate 12. The panel 44 is generally configured to facilitate removal of the dust wrapper 42 from the exterior surface of the plate 12. The panel 44 may be intrinsically formed with the dust wrapper 42. The panel 44 may be rectangular, although other shapes are also contemplated.

In use, the plate 12 can be positioned on the windshield 18 of the vehicle 20 to protect the central portion 24 of the windshield 18, over which the plate 12 is positioned, from damage. For example, the plate 12 can absorb impact damage to inhibit the windshield 18 from is cracked, chipped, or otherwise damaged by debris. The adhesive material 36 secures the plate 12 to the windshield 18.

The plate 12 may be coupled to the windshield 18 by removing the cover 38 from the adhesive material 36 using the tab 40. The plate 12 can then be placed over the outer surface 22 of the windshield 18, cover 38ing at least the central portion 24 of the windshield 18, as shown in FIG. 5. In other embodiments, the plate 12 may have the same dimensions as the windshield 18, such that the plate 12 is positionable to cover 38 the entire outer surface 22 of the windshield 18. Once the interior face 26 of the plate 12 is coupled to the outer surface 22 of the windshield 18, the dust wrapper 42 may be removed from the exterior face 28 of the plate 12. For example, the user may grip the panel 44 to remove the dust wrapper 42 from the exterior face 28 of the plate 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A windshield protection assembly comprising:
a plate having a peripheral shape being configured to be positionable within a perimeter edge of a windshield of a vehicle wherein the plate is configured to cover a central portion of the windshield, the plate including a tempered glass material wherein the tempered glass material is configured to inhibit impact damage to the windshield of the vehicle while the plate is positioned against the windshield; and
an adhesive material being positioned on an interior face of the plate wherein the adhesive material is configured to adhesively engage the windshield to adhesively couple the plate to the windshield.

2. The windshield protection assembly of claim 1, the plate further comprising the plate having a top edge, a bottom edge, and a pair of opposing lateral edges being coupled to and extending between the top edge and the bottom edge to define the peripheral shape.

3. The windshield protection assembly of claim 2, wherein the interior face of the plate is concavely arcuate between the pair of opposing lateral edges wherein the interior face is configured to be positionable flush against the windshield of the vehicle.

4. The windshield protection assembly of claim 3, the plate further comprising an exterior face being convexly arcuate between the pair of opposing lateral edges.

5. The windshield protection assembly of claim 4, the plate further comprising a thickness being measured between the interior face and the exterior face, the thickness being consistent across the plate within the peripheral shape.

6. The windshield protection assembly of claim 2, wherein the top edge is concavely arcuate between the pair of opposing lateral edges.

7. The windshield protection assembly of claim 2, wherein the bottom edge is convexly arcuate between the pair of opposing lateral edges.

8. The windshield protection assembly of claim 1, further comprising a cover being removably affixed to the adhesive material wherein the cover is configured to inhibit debris from damaging the adhesive material while the cover is affixed to the adhesive material.

9. The windshield protection assembly of claim 8, further comprising a tab being coupled to and extending from the cover, the tab being positioned to extend past the plate while the cover is affixed to the adhesive material wherein the tab is configured to facilitate removal of the cover from the adhesive material.

10. The windshield protection assembly of claim 9, wherein the tab is intrinsically coupled to the cover.

11. The windshield protection assembly of claim 1, further comprising a dust wrapper being removably affixed to an exterior face of the plate wherein the dust wrapper is configured to inhibit debris from damaging the exterior face of the plate while the dust wrapper is affixed to the exterior face of the plate.

12. The windshield protection assembly of claim 11, further comprising a panel being coupled to and extending from the dust wrapper, the panel being positioned to extend past the plate while the dust wrapper is affixed to the exterior face of the plate wherein the panel is configured to facilitate removal of the dust wrapper from the exterior surface of the plate.

13. The windshield protection assembly of claim 1, wherein the adhesive material is positioned to cover the interior face of the plate.

14. A windshield protection assembly comprising:
a plate having a peripheral shape being configured to be positionable within a perimeter edge of a windshield of a vehicle wherein the plate is configured to be positionable against an outer surface of the windshield of the vehicle and wherein the plate is configured to cover a central portion of the outer surface of the windshield, the plate including a tempered glass material wherein the tempered glass material is configured to inhibit impact damage to the windshield of the vehicle while the plate is positioned against the outer surface of the windshield, the plate being transparent wherein the plate is configured to facilitate visibility through the windshield, the plate having an interior face and an exterior face, the plate having a top edge, a bottom edge, and a pair of opposing lateral edges being coupled to and extending between the top edge and the bottom edge to define the peripheral shape, the interior face being concavely arcuate between the pair of opposing lateral edges wherein the interior face is configured to be positionable flush against the outer surface of the windshield of the vehicle, the exterior face being convexly arcuate between the pair of opposing lateral edges, the top edge being concavely arcuate between the pair of opposing lateral edges, the bottom edge being convexly arcuate between the pair of opposing lateral edges, the plate having rounded corners between the top edge and each opposing lateral edge of the pair of opposing lateral edges, the plate having rounded corners between the bottom edge and each opposing lateral edge of the pair of opposing lateral edges, the plate having a thickness being measured between the interior face and the exterior face, the thickness being consistent across the plate within the peripheral shape;
an adhesive material being positioned to cover the interior face of the plate wherein the adhesive material is configured to adhesively engage the outer surface of the windshield to adhesively couple the plate to the windshield, the adhesive material being transparent wherein the adhesive material is configured to facilitate visibility through the windshield;
a cover being removably affixed to the adhesive material wherein the cover is configured to inhibit debris from damaging the adhesive material while the cover is affixed to the adhesive material, the cover having a size being complementary to a size of the interior face of the plate wherein the cover is positioned to cover the adhesive material while the cover is affixed to the adhesive material;
a tab being coupled to and extending upwardly from the cover, the tab being positioned to extend upwardly past the top edge of the plate while the cover is affixed to the adhesive material wherein the tab is configured to facilitate removal of the cover from the adhesive material, the tab being intrinsically formed with the cover, the tab being rectangular;
a dust wrapper being removably affixed to the exterior face of the plate wherein the dust wrapper is configured to inhibit debris from damaging the exterior face of the plate while the dust wrapper is affixed to the exterior face of the plate, the dust wrapper having a size being complementary to a size of the exterior face of the plate wherein the dust wrapper is positioned to cover the exterior face of the plate while the dust wrapper is affixed to the exterior face of the plate; and
a panel being coupled to and extending downwardly from the dust wrapper, the panel being positioned to extend downwardly past the bottom edge of the plate while the dust wrapper is affixed to the exterior face of the plate wherein the panel is configured to facilitate removal of the dust wrapper from the exterior surface of the plate, the panel being intrinsically formed with the dust wrapper, the panel being rectangular.
